(19) United States
(12) Patent Application Publication
(10) Pub. No.: US 2007/0118586 A1
(43) Pub. Date: May 24, 2007

(54) Method and apparatus for delivering service guide contents and notification event information in a mobile broadcast system

(75) Inventors: Sung-Oh Hwang, Yongin-si (KR); Jae-Kwon Oh, Seoul (KR); Jong-Hyo Lee, Pyeongtaek-si (KR); Kook-Heui Lee, Yongin-si (KR); Byung-Rae Lee, Seoul (KR); Jae-Yong Lee, Seoul (KR); Bo-Sun Jung, Seongnam-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/594,481

(22) Filed: Nov. 7, 2006

(30) Foreign Application Priority Data
Nov. 7, 2005 (KR) 106209/2005
Mar. 3, 2006 (KR) 20674/2006

(51) Int. Cl. G06F 15/16

(52) U.S. Cl. 709/200

(57) ABSTRACT

A method and apparatus is provided for transmitting information necessary for generation of a notification event for a mobile broadcast (BCAST) service in a wireless communication system. A request message is generated including notification event information and appropriate attributes indicating a change in the BCAST service, and is transmitted to a Notification Event Function (NTE) in a BCAST Service Application block, which generates a notification event, and transmits a response message indicating the generation result to the CC. The NTE transmits the notification event to a function in a BCAST Subscription Management block to generate a notification message indicating the notification event, to be transmitted to a terminal receiving the BCAST service.

### PRIORITY

This application claims the benefit under 35 U.S.C. §119(a) of an application entitled “Method and Apparatus for Delivering Service Guide Contents and Notification Event Information in a Mobile Broadcast System” filed in the Korean Intellectual Property Office on Nov. 7, 2005 and assigned Serial No. 2005-106209, and an application entitled “Method and Apparatus for Delivering Service Guide Contents and Notification Event Information in a Mobile Broadcast System” filed in the Korean Intellectual Property Office on Mar. 3, 2006 and assigned Serial No. 2006-20674, the contents of both of which are incorporated herein by reference.

### BACKGROUND OF THE INVENTION

1. Field of the Invention

The present invention relates generally to a broadcast system or a mobile communication system supporting Broadcast Service (BCAST), and in particular, to a method and apparatus for delivering Service Guide (SG)-related content information and notification event which may occur in a content provider.

2. Description of the Related Art

Today, with the rapid development of communication and broadcast technologies, the mobile communication system is providing mobile broadcast service. There are ongoing discussions on mobile broadcast capable of transmitting packet data over a broadcast channel, as well as the conventional audio/video-oriented broadcast service. Mobile broadcast can include discovering a service by such mobile terminals as a mobile phone, notebook computer, and Personal Digital Assistant (PDA) capable of receiving mobile broadcast, subscribing to the service by the mobile terminal, providing various control information for receiving the service, and transmitting/receiving the service by the mobile terminal.

Open Mobile Alliance (OMA), a group which studies the standard for interworking between individual mobile solutions, mainly establishes various application standards for services such as mobile games and Internet services. Amongst OMA working groups, OMA Browser and Content (BAC) Mobile Broadcast Sub Working Group (BCAST) studies a technology for providing broadcast service using a mobile terminal.

In the mobile broadcast system under discussion in OMA, a mobile terminal for receiving broadcast service receives service guide (SG) information including description, charging and reception method information, and receives the corresponding service using the service guide information.

A part of the service guard information can vary. Therefore, every time a particular service changes, a service guide for the corresponding service is repeatedly transmitted. With mobile broadcast, in consideration of a new mobile terminal, a service guide for the mobile broadcast service is repeatedly transmitted even though there is no change in the service guide. For example, if there is a new user desiring to receive broadcast service by newly activating a mobile terminal, or if there is a mobile terminal that should receive a new service guide due to movement of its user, the mobile terminal receives the service guide independently of the mobile terminals that have already been receiving the mobile broadcast.

In such a mobile broadcast system, it is very important to reliably and efficiently deliver and respond to the notification event indicating the change in the service guide information and broadcast service. Therefore, there is a need for a detailed technology for delivering content information and notification event information based on which a content provider generates a BCAST service guide, determining information elements and attributes necessary for generating the associated messages, and sending a response indicating whether to perform the requirements.

### SUMMARY OF THE INVENTION

To substantially solve at least the above problems and/or disadvantages and to provide at least the advantages below, the present invention provides a method and apparatus for delivering content information and notification event information used for generating a service guide in a mobile broadcast system.

The present invention provides a method and apparatus for determining information elements and attributes necessary for generating messages related to transmission of a service guide and a notification event in a mobile broadcast system.

The present invention provides a method and apparatus for responding to generation results of a service guide and a notification event in a mobile broadcast system.

According to the present invention, there is provided a method for transmitting information necessary for generation of a notification event for a BCAST service in a wireless communication/broadcast system supporting the BCAST service, including generating, by a Content Creation (CC) for providing the BCAST service, a request message including notification event information and attributes for requesting generation of a notification event indicating a change in the BCAST service, and transmitting the request message to a Notification Event Function (NTE) in a BCAST Service Application (BSA) block, generating, by the NTE, a notification event using the notification event information and attributes included in the request message, and transmitting a response message indicating the generation result on the notification event to the CC, and transmitting, by the NTE, the notification event to a Notification Generation function (NTG) in a BCAST Subscription Management (BSM) block in order to generate a notification message indicating the notification event, to be transmitted to a terminal receiving the BCAST service.

According to the present invention, there is provided an apparatus for transmitting information necessary for generation of a notification event for a BCAST service in a wireless communication/broadcast system supporting the BCAST service, including a CC supporting the BCAST service, for generating a request message including notification event information and attributes for requesting generation of a notification event indicating a change in the BCAST service, an NTE in a BSA block, for generating a notification event using the notification event information and attributes included in the request message, and transmitting a response message indicating the generation result on the notification event to the CC, and an NTG in a BSM block, for receiving the notification event message from the NTE, and generating a notification message indicating the notification event, to be transmitted to a terminal receiving the BCAST service.

According to the present invention, there is provided a method for transmitting information necessary for generation of a service guide (SG) for a mobile broadcast (BCAST) service in a wireless communication/broadcast system supporting the BCAST service, including generating, by a Service Guide Content Creation Source (SGCCS) in a Content Creation (CC) for providing the BCAST service, a request message including a source data necessary for generation of the SG, and transmitting the source data to a Service Guide Application Source (SGAS) in a BCAST Service Application (BSA) block, forwarding, by the SGAS, the source data to Service Guide Generation (SG-G) block in a BCAST Service Distribution/Adaptation (BSD/A) block to generate the SG, and transmitting a response message indicating the processing result on the source data to the SGCCS, and generating, by the SG-G, the SG using the source data to be transmitted to at least one terminal receivable the BCAST service.

According to the present invention, there is provided an apparatus for transmitting information necessary for generation of a service guide (SG) a mobile broadcast (BCAST) service in a wireless communication/broadcast system supporting the BCAST service, including a Service Guide Content Creation Source (SGCCS) in a Content Creation (CC) providing the BCAST service, for generating a request message including a source data necessary for generation of the SG, a Service Guide Application Source (SGAS) in a BCAST Service Application (BSA) block, for receiving the request message including a source data, and transmitting a response message indicating the processing result on the source data to the SGCCS, and a Service Guide Generation (SG-G) block in a BCAST Service Distribution/Adaptation (BSD/A) block, for receiving the source data from the SGAS, and generating the SG using the source data, to be transmitted to at least one terminal receivable the BCAST service.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a mobile broadcast system that delivers a service guide to a mobile terminal according to the present invention;

FIG. 2 is a diagram illustrating structures of notification interfaces for providing notification messages in a mobile broadcast system according to the present invention;

FIG. 3 is a diagram illustrating a message flow between logical entities for providing a service guide in a mobile broadcast system according to the present invention;

FIG. 4 is a diagram illustrating a message flow between logical entities for providing a notification message in a mobile broadcast system according to the present invention;

FIG. 5 is a diagram illustrating a protocol stack used for transmitting content information related to a service guide in an SG-1 interface according to the present invention;

FIG. 6 is a signaling diagram illustrating an operation of transmitting content information via an SG-1 interface according to the present invention;

FIG. 7 is a diagram illustrating a protocol stack used for transmitting notification event information in an NT-1 interface according to the present invention;

FIG. 8 is a signaling diagram illustrating an operation of transmitting notification event information via an NT-1 interface according to the present invention;

FIG. 9 is a diagram illustrating a protocol stack used for providing a service guide source or requesting a notification event according to the present invention;

FIG. 10 is a signaling diagram illustrating an operation of delivering service guide source data according to the present invention; and

FIG. 11 is a signaling diagram illustrating an operation of delivering notification event information according to the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for the sake of clarity and conciseness.

In the following detailed description, although names of the entities defined in 3^{rd} Generation Partnership Project (3GPP) which is the asynchronous mobile communication standard, or BCAST of OMA will be used for convenience, the standards and names should not limit the scope of the present invention, and the present invention is applied to systems having a similar technical background. A detailed description of the present invention will now be made with reference to OMA BCAST, which is one of the mobile broadcast standards.

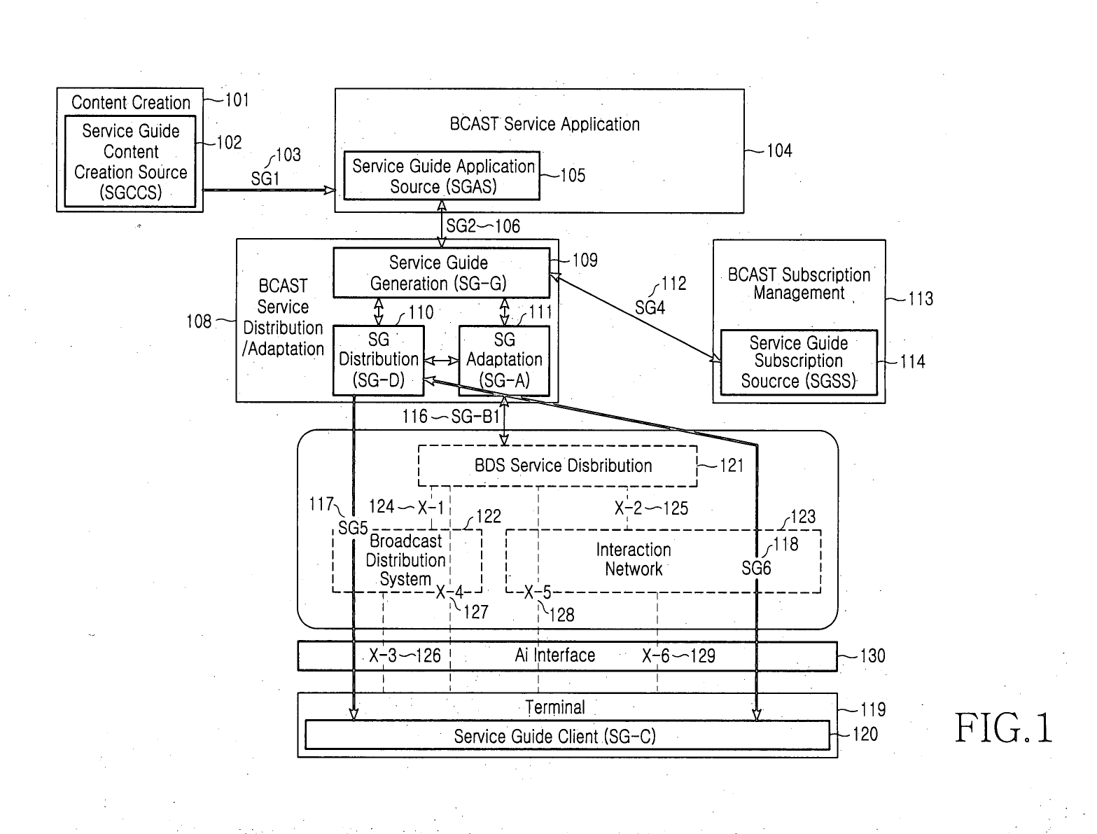

FIG. 1 is a diagram illustrating a mobile broadcast system that delivers a service guide to a mobile terminal according to the present invention. Interfaces used between elements (logical entities) of FIG. 1 are defined hereinbelow.

SG-1 (103): Server-to-server communications for delivering content attributes such as description information, location information, target terminal capabilities and target user profile, either in the form of BCAST service guide fragments or in a proprietary format.

SG-2 (106): Server-to-server communications for delivering BCAST service attributes such as service/content description information, scheduling information, location information, target terminal capabilities and target user profile, in the form of BCAST service guide fragments.

SG-B1 (116): Server-to-server communications for delivering Broadcast Distribution System (BDS) specific attributes from BDS to BCAST Service Guide Adaptation function, assisting in Service Guide adaptation to specific BDS, or delivering BCAST Service Guide attributes to BDS for BDS specific adaptation and distribution.

SG-4 (112): Server-to-server communications for delivering provisioning, purchase, subscription and promotional information, in the form of BCAST service guide fragments

SG-5 (117): Delivery of BCAST Service Guide through Broadcast Channel, over Internet Protocol (IP).

SG-6 (118): Delivery of BCAST Service Guide through Interaction Channel. Interactive access to retrieve Service Guide or additional information related to Service Guide, for example, by Hypertext Transfer Protocol (HTTP), Short Message Service (SMS) or Multimedia Messaging System (MMS).

X-1 (124): Reference Point between BDS Service Distribution and BDS.

X-2 (125): Reference Point between BDS Service Distribution and Interaction Network.

X-3 (126): Reference Point between BDS and Terminal.

X-4 (127): Reference Point between BDS Service Distribution and Terminal over Broadcast Channel.

X-5 (128): Reference Point between BDS Service Distribution and Terminal over Interaction Channel.

X-6 (129): Reference Point between Interaction Network and Terminal.

Referring to FIG. 1, a Content Creation block (CC), or content provider 101 is a provider of BCAST, which can include the conventional audio/video broadcast service and music/data file download service. The CC 101, including a Service Guide Content Creation Source (SGCCS) 102, delivers content information necessary for creation of a BCAST service guide, capability information of mobile terminals, user profile, and content time information to a Service Guide Application Source (SGAS) 105 of a BSA block 104 through the SG-1 interface 103.

The BCAST Service Application block 104 processes data of the BCAST service provided from the CC 101 in the form appropriate for a BCAST network, making BCAST service data. In addition, the BCAST Service Application block 104 generates standardized metadata necessary for the mobile broadcast guide. The SGAS 105 generates service guide source data including various information necessary for creation of scheduling and location information, including the service and content information provided from the SGCCS 102, and delivers the generated service guide source data to a Service Guide Generation (SG-G) 109 of a BCAST Service Distribution/Adaptation (BSD/A) block 108 through the SG-2 interface 106.

The BCAST Service Distribution/Adaptation block 108 has functions for setting up a bearer over which it will transmit the BCAST service data provided from the BCAST Service Application block 104, determining transmission scheduling of the BCAST service and creating mobile broadcast guide information. The BCAST Service Distribution/Adaptation block 108 is connected to a Broadcast Distribution System (BDS) 122, which is a network for transmitting BCAST service data, and an Interaction Network 123 supporting interactive communication.

The SG-G 109 generates a service guide using the service guide source data, and delivers the service guide to an SG Distribution (SG-D) 110 so that the service guide is delivered to a Terminal 119 via the SG-5 interface 117. If the service guide is delivered via the BDS 122 or the Interaction Network 123, or if the BCAST Service Distribution/Adaptation block 108 is matched to a particular system or network, the service guide generated from the SG-G 109 is matched to the corresponding system or network in an SG Adaptation (SG-A) 111, and then delivered via the SG-D 110 or delivered to a BDS Service Distribution block 121 via the SG-B1 interface 116.

A BCAST Subscription Management (BSM) block 113 manages subscription information and service provisioning information for receipt of BCAST service, and device information for a terminal receiving BCAST service. A Service Guide Subscription Source (SGSS) 114 of the BCAST Subscription Management block 113 delivers such source data as source and purchase information related to generation of service guide, subscription, and provisioning, and message-related information to the SG-G 109 that generates the service guide, via the SG-4 interface 112.

The BDS Service Distribution block 121 serves to distribute all received BCAST services through a broadcast channel or an interaction channel, and can either exist or not exist according to type of the BDS 122. The BDS 122 can be a broadcast network such as Digital Video Broadcasting-Handheld (DVB-H), 3GPP-based Multimedia Broadcast and Multicast Services (MBMS) and 3GPP2-based Broadcast and Multicast Services (BCMCS). The Interaction Network 123 individually transmits BCAST data, or interactively exchanges control information and additional information related to reception of the BCAST service, and can be, for example, the existing cellular network.

The Terminal 119 is an apparatus capable of receiving the BCAST service, and can be connected to the cellular network according to terminal capability. The Terminal 119, including a Service Guide Client (SG-C) 120, receives the service guide transmitted via the SG-5 interface 117 or the SG-6 interface 118, thereby performing an appropriate operation for receipt of the BCAST service.

A brief description will now be made of functions of the key elements (logical entities) of FIG. 1 in the OMA BCAST service standard.

Content Creation (101): Service Guide Content Creation Source (SGCCS) may provide contents and attributes such as content description information, target terminal capabilities, target user profile and content timing information, and sends them over SG-1 103 in the form of standardized BCAST Service Guide fragments, or in a proprietary format.

BCAST Service Application (104): Includes Service Guide Application Source 105 (SGAS) which provides information such as service/content description, scheduling and location information, and target terminal capabilities and target user profile, and sends them over SG-2 106 in the form of standardized BCAST Service Guide fragments.

BCAST Subscription Management (113): Includes Service Guide Subscription Source 114 (SGSS) which provides provisioning, purchase, subscription and promotional information, and sends them over SG-4 112 in the form of Service Guide fragments.

Service Guide Generation (SG-G) (109): Responsible for receiving Service Guide fragments from various sources such as SGCCS, SGAS, SGSS over SG-2 106 and SG-4 112 interfaces. SG-G assembles the fragments such as services and content access information, according to a standardized schema, and generates Service Guide that is sent to Service Guide Distribution (SG-D) 110 for transmission. Before transmission, it is optionally adapted in the Service Guide Adaptation Function (SG-A) 111 to suit a specific BDS.

Service Guide Client Function (SG-C) (120): Responsible for receiving the Service Guide information from the underlying BDS, and making the Service Guide available to the mobile terminal. The SG-C obtains specific Service Guide information. It may filter it to match the terminal specified criteria (e.g., location, user profile and terminal capabilities), or it simply obtains all available Service Guide information. Commonly, the user may view the Service Guide information in a menu, list or tabular format. SG-C may send a request to the network through SG-6 118 to obtain specific Service Guide information or the whole Service Guide.

Service Guide Distribution (SG-D) (110): Generates an IP flow to transmit Service Guide over the SG-5 117 interface and the broadcast channel to the SG-C 120. Before transmission, the SG-G 109 may send Service Guide to SG-A 111 to adapt the Service Guide to suit specific BDS 122, according to the BDS attributes sent by BDS Service Distribution 121 over SG-B1 116. The adaptation might result in modification of the Service Guide. Note that, for adaptation purpose, the SG-A 111 may also send the BCAST Service Guide attributes or BCAST Service Guide fragments over SG-B1 116 to BDS Service Distribution 121 for adaptation. However, this adaptation within BDS Service Distribution 121 is out of the scope of BCAST. SG-D 110 may also receive a request for Service Guide information, send the requested Service Guide information to the terminal directly through the interaction channel, and filter Service Guide information from SG-G 109 based on End User's pre-specified profile. SG-D 110 may further send the Service Guide to the BDS 122, which modifies the Service Guide (e.g., by adding BDS specific information), and further distributes the Service Guide to the SG-C 120 in a BDS specific manner.

Aside from transmission of the service guide, the mobile broadcast system transmits the contents (i.e. notification event) that it desires to notify, along with a notification message, when there is a problem in providing the BCAST services which are being provided or can be provided, or there is a change in the service guide, or in the mobile broadcast service that it desires to notify to the mobile terminal.

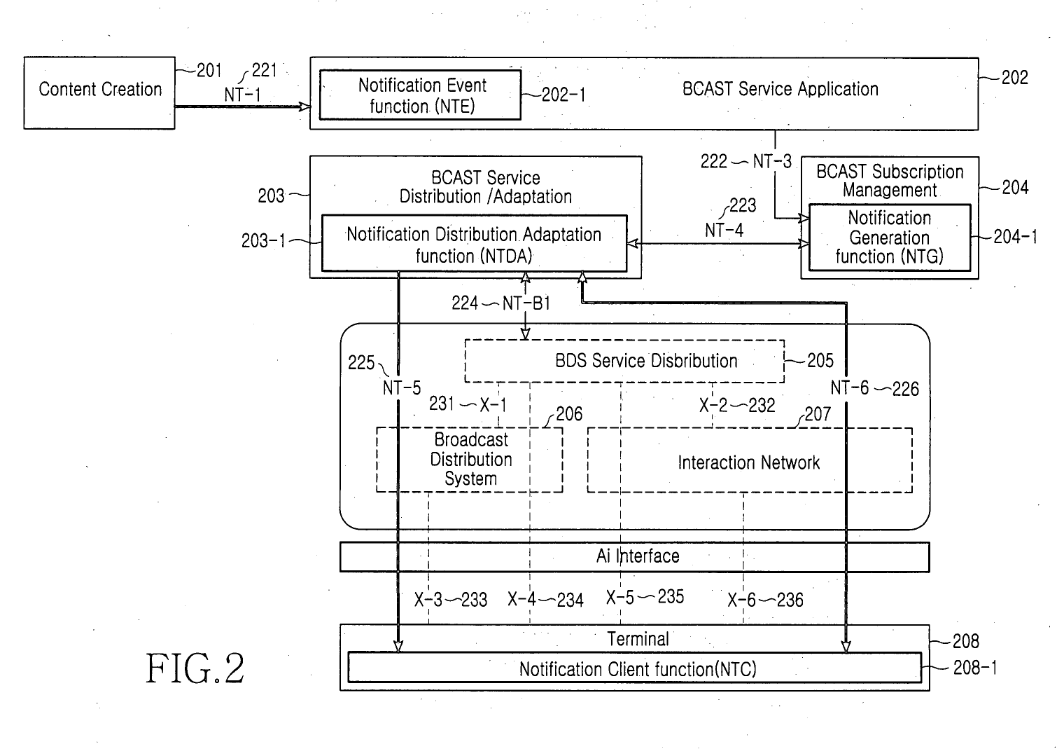

FIG. 2 is a diagram illustrating structures of notification interfaces for providing notification messages in a mobile broadcast system according to the present invention. A notification event may occur in several logical entities, and information on a notification event occurring in each logical entity is delivered to other logical entities along corresponding interfaces, so the other logical entities can generate a notification event or a notification message according to the notification event.

Referring to FIG. 2, a CC 201 is a provider of BCAST service, which can include the conventional audio/video broadcast service and music/data file download service. When there is a problem in providing BCAST service or there is a change in the BCAST service, the CC 201 notifies the change to a Notification Event Function (NTE) 202-1 located in a BSA block 202.

The BSA block 202 processes data of the BCAST service provided from the CC 201 in the form appropriate for a BCAST network, making BCAST service data, and generates standardized metadata necessary for mobile broadcast guide. In addition, the BSA block 202 includes the Notification Event Function 202-1 for notifying the change in the BCAST service provided from the CC 201 to a Notification Generation function (NTG) 204-1 located in a BSM block 204.

A BCAST Service Distribution/Adaptation (BSD/A) block 203 is responsible for setting up a bearer over which it will transmit the BCAST service data provided from the BCAST Service Application block 202, determining transmission scheduling of the BCAST service, and generating mobile broadcast guide, and is connected to a BDS 206 for actually providing the BCAST service and an Interaction Network 207 supporting interactive communication. In addition, as the BCAST Service Distribution/Adaptation block 203 includes a Notification Distribution Adaptation function (NTDA) 203-1, it receives the notification message transmitted from the BCAST Subscription Management block 204 and transmits the notification message to one or a plurality of users via the BDS 206 or the Interaction Network 207.

The BCAST Subscription Management block 204 manages subscription information for receipt of the BCAST service, service provisioning information, and device information for a device receiving the BCAST service. In particular, as the BCAST Subscription Management block 204 includes the Notification Generation function 204-1, it generates a notification message by receiving the information on a notification event from the CC 201 or the BDS 206, or generates a notification message for the BCAST service event.

A BDS Service Distribution 205 serves to distribute all received BCAST services through a broadcast channel provided by the BDS 206 or an interaction channel provided by the Interaction Network 207, and can either exist or not exist according to type of the BSD 206.

The BDS 206 transmits BCAST service, and can be, for example, DVB-H, 3GPP-based MBMS or 3GPP2-based BCMCS. In addition, when there is a change in transmitting a particular BCAST service, the BDS 206 transmits a notification event indicating the change to the BCAST Service Distribution/Adaptation block 203 via an X-1 interface 231 or an NT-B1 interface 224 if the BDS Service Distribution 205 exists.

The Interaction Network 207 transmits BCAST data on an individual basis, or interactively exchanges control information and additional information related to reception of the BCAST service, and can be, for example, the existing cellular network.

A Terminal 208 is an apparatus capable of receiving the BCAST service, and can be connected to the cellular network according to terminal capability. For example, the Terminal 208 includes a terminal such as a cellular phone, capable of connecting with the cellular network. The Terminal 208 performs an appropriate operation by receiving a notification message transmitted via an NT-5 interface 225 by a Notification Client function (NTC) 208-1, or performs an appropriate operation by receiving a notification message transmitted via an NT-6 interface 226.

A description will now be made of interfaces between key logical entities of FIG. 2.

An NT-1 interface 221, an interface between the Notification Event Function 202-1 located in the BCAST Service Application block 202 and the CC 201, is used for delivering a notification event occurring in the CC 201 to the Notification Event Function (NTE) 202-1.

An NT-3 interface 222, an interface between the NTE 202-1 located in the BCAST Service Application block 202 and the Notification Generation function (NTG) 204-1 of the BCAST Subscription Management block 204, delivers information necessary for generation of a notification event or a notification message so that the NTG 204-1 can generate the notification message.

An NT-4 interface 223, an interface between the NTG 204-1 located in the BCAST Subscription Management block 204 and the Notification Distribution Adaptation function (NTDA) 203-1 of the BCAST Service Distribution/Adaptation block 203, is used for transmitting the notification message generated in the NTG 204-1 to the NTDA 203-1 so that it is transmitted via the BDS 206 or the Interaction Network 207, or delivering the notification event occurred in the BDS 206 from the NTDA 203-1 to the NTG 204-1.

An NT-5 interface 225 is an interface used when a notification message transmitted from the NTDA 203-1 of the BCAST Service Distribution/Adaptation block 203 is directly transmitted to the Terminal 208 through the broadcast channel. The NT-5 interface 225 is used for transmitting a notification message to one or a plurality of terminals.

An NT-6 interface 226 is an interface used when a notification message transmitted from the NTDA 203-1 of the BCAST Service Distribution/Adaptation block 203 is directly transmitted to the Terminal 208 through the dedicated channel for the Terminal 208 via the Interaction Network 207 or through the broadcast channel provided in the Interaction Network 207. The NT-6 interface 226 is used for transmitting the notification message to one or a plurality of terminals.

An NT-B1 interface 224, an interface between the BCAST Service Distribution/Adaptation block 203 and the BDS Service Distribution 205, is used for establishing a transmission path to be used in the BDS 206 by the BCAST Service Distribution/Adaptation block 203, or a reception path of the notification event occurred in the BDS 206.

An X-1 interface 231, an interface between the BCAST Service Distribution/Adaptation block 203 and the BDS 206, is used for establishing a transmission path to be used in the BDS 206 by the BCAST Service Distribution/Adaptation block 203 or a reception path of the notification event occurred in the BDS 206 when the BDS Service Distribution 205 does not exist. When the BDS Service Distribution 205 exists, the X-1 interface 231 is used as an interface between the BDS 206 and the BDS Service Distribution 205, for delivering the notification event occurred in the BDS 206.

An X-2 interface 232, an interface between the BCAST Service Distribution/Adaptation block 203 and the Interaction Network 207, is used for establishing a transmission path to be used in the Interaction Network 207 by the BCAST Service Distribution/Adaptation block 203 when the BDS Service Distribution 205 does not exist. When the BDS Service Distribution 205 exists, the X-2 interface 232 is used as an interface between the BDS 206 and the Interaction Network 207, for setting up a bearer over which the notification message will be transmitted in the Interaction Network 207.

An X-3 interface 233, an interface between the BDS 206 and the Terminal 208, is used for the BCAST service or all messages transmitted through the broadcast channel.

An X-4 interface 234 is a broadcast channel interface between the BDS Service Distribution 205 and the Terminal 208.

An X-5 interface 235 is an interaction channel interface between the BDS Service Distribution 205 and the Terminal 208.

An X-6 interface 236 is an interaction channel interface with which the Interaction Network 207 can transmit BCAST service-related control information.

The Notification Event Function 202-1 delivers the information necessary for generating a notification message to the NTG 204-1, and upon recognizing occurrence of a notification-required event (i.e. notification event), delivers information on the notification event to the NTG 204-1. The NTG 204-1 generates a notification message by receiving the notification event and the information necessary for generation of the notification message from the NTE 202-1, or generates a notification message using the notification event of the BDS 206 received through the NTDA function 203-1, and transmits the generated notification message to the NTDA 203-1. The notification message can be generated (i) when there is a need to re-notify start of the service, (ii) when there is a need to transmit a new mobile broadcast guide upon receipt of a notification indicating a change in the service information from the CC 201, and (iii) when a particular event occurs in the BDS 206.

The NTDA 203-1 serves to transmit a notification message via the NT-5 225 or the NT-6 226, and upon receiving from the BDS 206 a notification indicating a change in a particular mobile broadcast service, for example, indicating adjustment of a data rate based on the wireless network environment or impossibility of the service, serves to deliver the corresponding notification event to the NTG 204-1 via the NT-4 223.

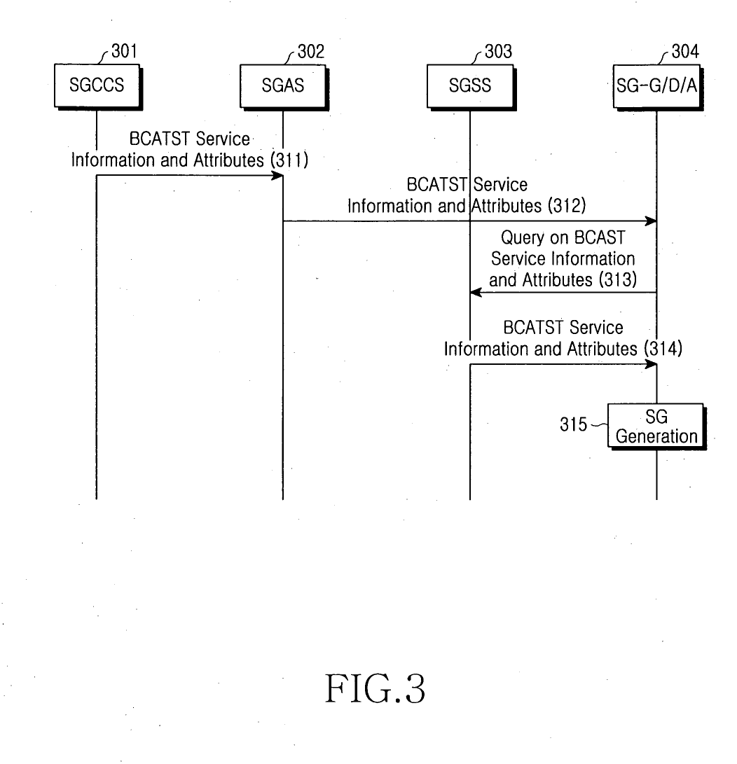

FIG. 3 is a diagram illustrating a message flow between logical entities for providing a service guide in a mobile broadcast system according to the present invention. Herein, reference numeral 301 indicates the SGCCS 102 in the CC 101, reference numeral 302 indicates the SGAS 105 in the BCAST Service Application block 104, reference numeral 303 indicates the SGSS 114 in the BCAST Subscription Management block 113, and reference numeral 304 indicates the SG-G/D/A 109, 110 and 111 in the BCAST Service Distribution/Adaptation block 108.

Referring to FIG. 3, in step 311, the SGCCS 301 delivers broadcast content information and attributes associated with the BCAST service to the SGAS 302 using an SG-1 interface. In step 312, the SGAS 302 delivers the broadcast content/service information and attributes to the SG-G/D/A 304 via an SG-2 interface according to a BCAST format using the attributes provided from the SGCCS 301. In step 313, the SG-G/D/A 304 can request provisioning-related information for the corresponding service to the SGSS 303 depending on the broadcast content/service information and attributes. In step 314, the SGSS 303 provides the requested provisioning-related information to the SG-G/D/A 304. In step 315, the SG-G/D/A 304 generates a service guide (SG) depending on the provided information, and the service guide is delivered to the mobile terminal via the BDS or the interaction network as described above.

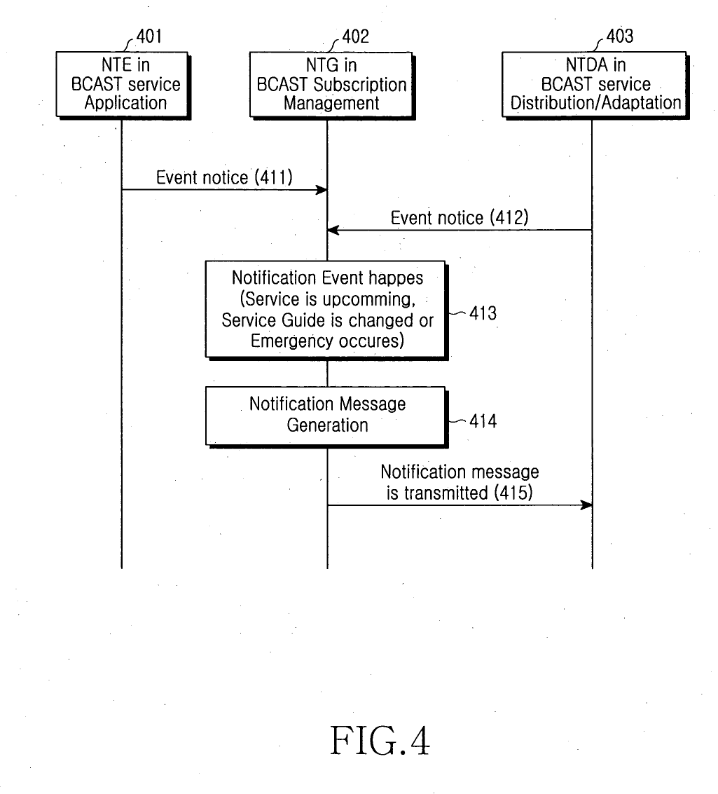

FIG. 4 is a diagram illustrating a message flow between logical entities for providing a notification message in a mobile broadcast system according to the present invention. Herein, reference numeral 401 indicates the NTE 202-1 in the BCAST Service Application block 202, reference numeral 402 indicates the NTG 204-1 in the BCAST Subscription Management block 204, and reference numeral 403 indicates the NTDA 203-1 in the BCAST Service Distribution/Adaptation block 203.

Referring to FIG. 4, a notification event is generated in the NTE 401 or the NTDA 403 and then delivered to the NTG 402, or is generated in the BCAST Subscription Management block 204 or the BDS 206. That is, if a notification event occurs in the CC 201 or the BSA 202, the NTE 401 delivers in step 411 an Event notice including notification event information to the NTG 402 through the NT-3 interface 222. If the notification event has occurred in the BCAST Service Distribution/Adaptation block 203 or the BDS 206, the notification event information is delivered from the NTDA 403 to the NTG 402 via the NT-4 interface 223 in step 412. In step 413, a notification event may occur in the BSM 204 and the occurrence may be notified to the NTG 402. For example, the notification event occurs when the service is upcoming, a service guide is changed or an emergency occurs.

As described above, the NTG 402 is spontaneously provided with the notification event information via the NT-3 interface 222 or the NT-4 interface 223. In step 414, the NTG 402 generates a notification message according to the notification event information, and then delivers the notification message to the NTDA 403 via the NT-4 interface 223, so that the notification message can be delivered to the Terminal 208 via the BDS 206 or the Interaction Network 207.

Although it is shown in FIG. 4 that the notification event occurs in the BCAST Service Application block 202, the BCAST Service Distribution/Adaptation block 203, the BCAST Subscription Management block 204, or the BDS 206, the notification event may occur even in the CC 201 when, for example, there is a failure in the CC 201 or a change in the service guide.

A description will now be made of a detailed information format and operation procedure for generating content information for the service guide in the SGCCS 102 of the CC 101 and allowing the SGAS 105 of the BSA 104 to generate a service guide, and a detailed information format and operation procedure for generating a notification event in the CC 201 and allowing the NTE 202-1 of the BSA 202 to generate notification event information.

Prior to doing so, each column of a message schema table used in the present invention will be described for a better understanding of the invention. ‘Name’ indicates names of elements and attributes constituting the corresponding message. ‘Type’ indicates whether the corresponding name corresponds to the type of an element or an attribute. Each element has values of E1, E2, E3 and E4. E1 indicates an upper element for the entire message, E2 indicates sub-element of E1, E3 indicates a sub-element of E2, and E4 indicates a sub-element of E3. The attribute is indicated by A, and A indicates an attribute of the corresponding element. For example, A under E1 indicates an attribute of E1. ‘Category’ is used for indicating whether a corresponding element or attribute is mandatory, and has a value M if the value is mandatory, and a value O if the value is optional. ‘Cardinality’ indicates relations between the elements, and has values of ‘0’, ‘0 . . . 1’, ‘1’, ‘0 . . . n’, and ‘1 . . . n’, where “0” indicates an optional relation, “1” indicates a mandatory relation, and ‘n’ indicates the possibility of having a plurality of values. For example, ‘0 . . . n’ indicates the possibility that there is no corresponding element or there are n corresponding elements. ‘Description’ defines the meaning of the corresponding element or attribute. ‘Data Type’ indicates a data type of the corresponding element or attribute. The message format is shown in Table 1 below.

TABLE 1

| | | | | | |
|---|---|---|---|---|---|
| Name | Type | Category | Cardinality | Description | Data Type |

Although several information elements necessary for generation request/response of service guide and notification event according to the present invention will be described herein, the messages proposed in the present invention should not necessarily include all of the information elements, and can include some or all of the information elements according to an intention or need of the designer.

FIG. 5 is a diagram illustrating a protocol stack used for transmitting content information related to a service guide in an SG-1 interface according to the present invention. Herein, reference numeral 501 indicates the SG-1 interface 103 of FIG. 1.

Referring to FIG. 5, messages delivered via the SG-1 interface 501 can have a text or Extensible Markup Language (XML) format. The format of the messages will be described in detail hereinbelow. The messages over the SG-1 interface 501 are transmitted using an IP 503, a Transfer Control Protocol (TCP) 505, and an HTTP 507, and the SGCCS 102 in the CC 101 transmits service guide-related content information to the SGAS 105 in the BSA 104 using an HTTP POST scheme. The HTTP POST scheme, unlike the HTTRP GET scheme using a Universal Resource Locator (URL), delivers data using a file without length limitation. After receipt of the content information from the SGCCS 102, the SGAS 105 transmits the generation result on the service guide source data along with an HTTP RESPONSE message or an HTTP POST message.

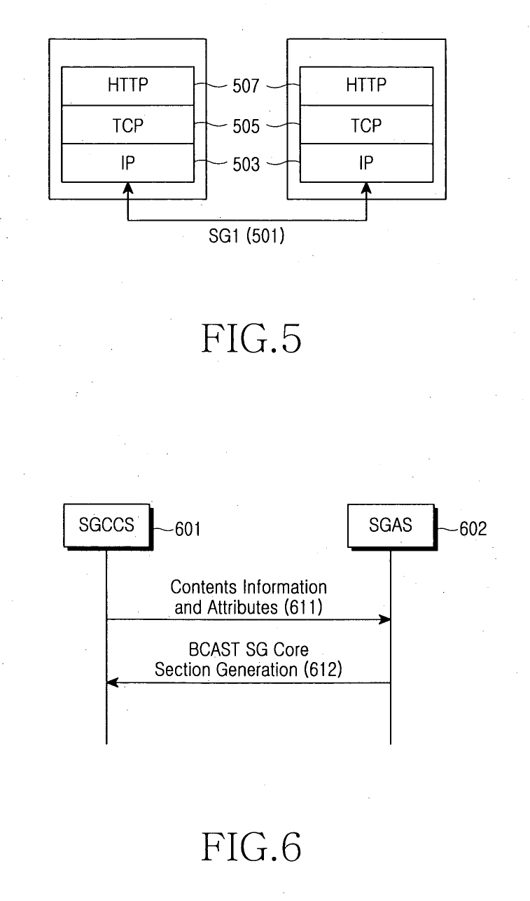

FIG. 6 is a signaling diagram illustrating an operation of transmitting content information via an SG-1 interface according to the present invention. Herein, reference numeral 601 indicates the SGCCS 102 of FIG. 1, and reference numeral 602 indicates the SGAS 105 of FIG. 1.

Referring to FIG. 6, in step 611, the SGCCS 601 sends the content information and attributes necessary for service guide generation to the SGAS 602 along with a request message. The request message provided in step 611 is equal to an SGCCSReq message shown in Table 2 below. The SGAS 602 generates service guide source data using additional information necessary for the content information and attributes received from the SGCCS 601, and then sends the generation result on the service guide source data to the SGCCS 601 along with a response message in step 612. The response message is equal to an SGCCSRes message shown in Table 3 below.

When the service guide source data is immediately generated according to the content information, the SGAS 602 sends the generation result on the service guide source data along with an HTTP RESPONSE message corresponding to the request message used in step 611. On the contrary, if the service guide source data is not immediately generated, a session between the SGAS 602 and the SGCCS 601 is ended after the SGCCSReq message is delivered. Thereafter, at the generation end time of the service guide source data, the SGAS 602 notifies the generation result on the service guide source data along with an HTTP POST response message using Service Guide Source (SGS) Identifier (Id) and/or logical Entity Address included in the SGCCSReq message. Specifically, the SGSId is an SGCCSId, and the Entity Address is a CC Address. The SGAS 602 can send the generation results on the several request messages of the SGCCS 601 to the SGCCS 601 along with one response message, and the results are identified with the SGCCSId and/or CCAddress included in the request messages.

TABLE 2

| Name | Type | Category | Cardinality | Description | Data Type |
|---|---|---|---|---|---|
| SGCCSReq | E | M | 1 | Specifies Service Guide Contents | |
| | | | | Creation Sources that includes | |
| | | | | contents information and attributes. | |
| | | | | Contains the Following attributes: | |
| | | | | SGCCSId | |
| | | | | Contains the following elements: | |
| | | | | Content | |
| SGCCSId | A | M | 1 | Identifier of SGCCSReq which is the | unsignedInteger |
| | | | | message for SGCCS to transfer | (32 bits) |
| | | | | Service Guide Contents Creation | |
| | | | | Source to SGAS | |
| CCAddress | A | M | 1 | CC Address to receive the response of | AnyURI |
| | | | | this request. | |
| Content | E1 | M | 1 . . . N | Specifies Content Information | |
| | | | | Contains the following attributes: | |
| | | | | CCContentID | |
| | | | | Contains the following sub-elements: | |
| | | | | ContentInfo | |
| | | | | Name | |
| | | | | Description | |
| | | | | ParentalRating | |
| | | | | TargetUserProfile | |
| | | | | Genre | |
| CCContentID | A | M | 1 | Identifier of Contents generated by | AnyURI |
| | | | | CC | |
| ContentInfo | E2 | M | 1 | Specifies the Content information | |
| | | | | provided by CC | |
| | | | | Contains the following attributes: | |
| | | | | ContentType | |
| | | | | ContentLength | |
| | | | | ContentEncoding | |
| ContentType | A | M | 1 | Type of the media content, .defined by | String |
| | | | | MIME media types [RFC2046] | |
| Content- | A | O | 0 . . . 1 | See RFC 3926, section 3.4.2 | unsignedLong |
| Length | | | | | |
| Content- | A | O | 0 . . . 1 | See RFC 3926, section 3.4.2 | String |
| Encoding | | | | | |
| Name | E2 | M | 1 . . . N | Name of the Content fragment, | String |
| | | | | possibly in multiple languages. The | |
| | | | | language is expressed using built-in | |
| | | | | XML attribute xml:lang with this | |
| | | | | element. | |
| Description | E2 | O | 0 . . . N | Description, possibly in multiple | String |
| | | | | languages. | |
| | | | | The language is expressed using built- | |
| | | | | in XML attribute xml:lang with this | |
| | | | | element. | |
| ParentalRating | E2 | O | 0 . . . 1 | The rating level defining criteria | Integer |
| | | | | parents may use to determine whether | |
| | | | | the associated item is suitable for | |
| | | | | access by children, defined according | |
| | | | | to the regulatory requirements of the | |
| | | | | service area The recommended age | |
| | | | | limit. | |
| | | | | This age limit rating level overrides | |
| | | | | the rating level age limit defined for | |
| | | | | the service during the validity of the | |
| | | | | Schedule fragment. | |
| | | | | If there are two overlapping schedule | |
| | | | | fragments with a different parental | |
| | | | | rating, then the one with most | |
| | | | | restrictive parental rating defined for | |
| | | | | the schedule fragment overrides the | |
| | | | | other. | |
| TargetUserProfile | E2 | O | 0 . . . 1 | Profile of the users who the service or | |
| file | | | | content is targeting at. For example, | |
| | | | | age, gender, occupation, etc. Details | |
| | | | | of the sub-elements TBD. | |
| Genre | E2 | O | 0 . . . 1 | Classification of content associated | String |
| | | | | with characteristic form (e.g. comedy, | |
| | | | | drama) | |

The key information elements in Table 2 will be described hereinbelow.

SGCCSId is a unique identifier indicating the SGCCSReq message delivered by the SGCCS, and is expressed in a 32-bit unsigned integer. CCAddress indicates a URL address of the CC that desires to receive a response to the SGCCSReq message. Service guide-related information, i.e. ‘Content’ which is an information element indicating service guide source data, includes CCContentID as an attribute, and ContentInfo, Name of the Content Fragment, Description, ParentalRating, TargetUserProfile, and Genre as sub-elements.

TABLE 3

| Name | Type | Category | Cardinality | Description | Data Type |
|---|---|---|---|---|---|
| SGCCSRes | E | M | 0 . . . N | Specifies the Response message for | |
| | | | | SGCCSReq. | |
| | | | | Contains the following elements: | |
| | | | | SGCCSId | |
| SGCCSId | E1 | M | 0 . . . N | Identifier of SGCCSReq Message | unsignedInteger |
| | | | | provided by SGCCS | (32 bits) |
| | | | | Contains the following attributes: | |
| | | | | Response | |
| Response | A | M | 1 | Specifies the result how SGCCSReq is | Interger |
| | | | | handled in SGAS. | (8 bits) |
| | | | | If Response = 0, Service Guide | |
| | | | | Application Source is generated | |
| | | | | If Response = 1, Service Guide | |
| | | | | Application Source Generation is failed | |
| | | | | and Retransmission is requested. | |

As shown in Table 3, SGCCSId included in the SGCCSRes message is equal to that included in the corresponding SGCCSReq message. An attribute ‘Response’ indicating the generation result on the service guide source data can have one of a Status Code=‘0’ indicating Success and a Status Code=‘1’ indicating Fail.

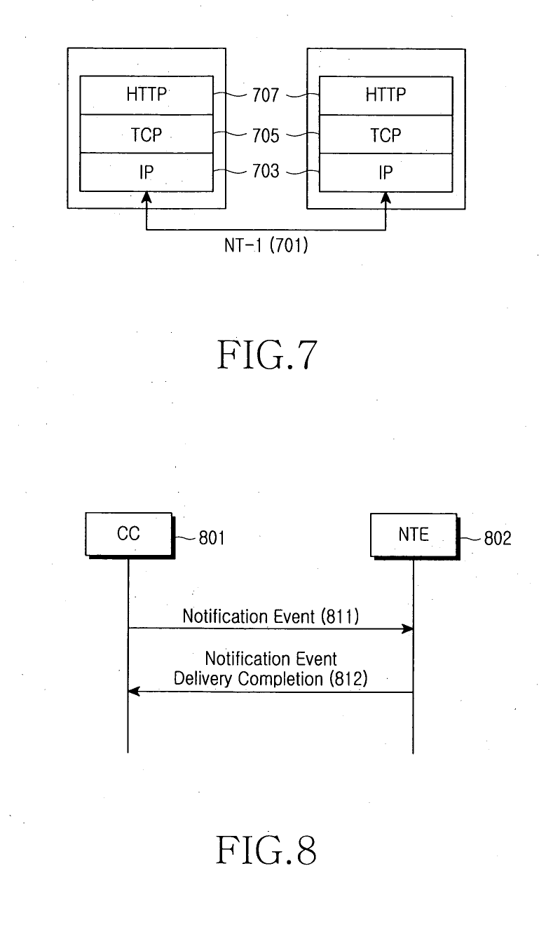

FIG. 7 is a diagram illustrating a protocol stack used for transmitting notification event information in an NT-1 interface according to the present invention. Herein, reference numeral 701 indicates the NT-1 interface 221 of FIG. 2.

Referring to FIG. 7, messages delivered via the NT-1 interface 701 can have a text or XML format. The format of the messages will be described in detail hereinbelow. The messages over the NT-1 interface 701 are transmitted using an IP 703, a TCP 705 and an HTTP 707, and the CC 201 transmits notification event information to the NTE 202-1 in the BSA 202 using the HTTP POST scheme. After receipt of the notification event information from the CC 201, the NTE 202-1 transmits the generation result on the notification event along with an HTTP RESPONSE message or an HTTP POST message.

FIG. 8 is a signaling diagram illustrating an operation of transmitting notification event information via an NT-1 interface according to the present invention. Herein, reference numeral 801 indicates the CC 201 of FIG. 2, and reference numeral 802 indicates the NTE 202-1 of FIG. 2.

Referring to FIG. 8, in step 811, the CC 801 transmits notification event information for requesting generation of a notification event to the NTE 802 along with a request message. The request message provided in step 811 is equal to a CCNTEReq message shown in Table 4 below, and includes notification event information. The NTE 802 generates a notification event using the notification event information received from the CC 801, and then sends a response message indicating the completed generation of the notification event to the CC 801 in step 812. The response message is equal to a CCNTERes message shown in Table 5 below.

When the notification event is immediately generated according to the notification event information, the NTE 802 sends the generation result on the notification event along with an HTTP RESPONSE message in response to the request message provided in step 811. On the contrary, if the notification event is not immediately generated, the NTE 802 ends the session between the CC 801 and the NTE 802 after the CCNTEReq message is delivered. Thereafter, at the generation end time of the notification event, the NTE 802 notifies the generation result on the notification event to the CC 801 along with an HTTP POST response message using CCNTEId and CCAddress included in the CCNTEReq message. The CCNTERes message can include the results on several request messages of the CC 801, and the results are identified with CCNTEId and/or CCAddress included in the request messages.

TABLE 4

| Name | Type | Category | Cardinality | Description | Data Type |
|---|---|---|---|---|---|
| CCNTEReq | E | M | 1 | Specifies the Request message of | |
| | | | | Notification Event from CC. | |
| | | | | Contains the following elements: | |
| | | | | CCNTEId | |
| | | | | CCAddress | |
| CCNTEId | A | M | 1 | Identifier of Notification Event from | AnyURI |
| | | | | CC | |
| CCAddress | A | M | 1 | CC Address to receive the response of | AnyURI |
| | | | | this request. | |
| NotificationEvent | E1 | M | 1 . . . N | Specifies the Notification Event from | |
| | | | | CC | |
| | | | | Contains the following attributes: | |
| | | | | NotificationType | |
| | | | | Validity | |
| | | | | Contains the following elements: | |
| | | | | Name | |
| | | | | Description | |
| | | | | Priority | |
| | | | | ExtensionURL | |
| | | | | MediaInformation | |
| NotificationType | A | M | 1 | Notification Type: | Integer |
| | | | | If NotificationType = 0, this message is | |
| | | | | user-oriented message, such as notice | |
| | | | | from SP, Multimedia message and | |
| | | | | emergency. | |
| | | | | Editor's Note: For emergency | |
| | | | | notification, it is TBD if this is | |
| | | | | adequate mechanism. | |
| | | | | Other NotificationType can be | |
| | | | | determined due to service providers, | |
| | | | | operators, or broadcasters' purpose | |
| Validity | A | O | 0 . . . 1 | Valid time of Notification message | Integer (32 |
| | | | | fragment. | bits) |
| | | | | If Validity is specified, Notification | expressed |
| | | | | message should be expired at the | as NTP |
| | | | | specified time. | time |
| Name | E2 | O | 0 . . . N | Name or title of notification message, | String |
| | | | | possibly in multiple languages. | |
| | | | | The language is expressed using built- | |
| | | | | in XML attribute xml:lang with this | |
| | | | | element. | |
| Description | E2 | O | 0 . . . N | Description or Messages of | String |
| | | | | Notification, possibly in multiple | |
| | | | | languages | |
| | | | | The language is expressed using built- | |
| | | | | in XML attribute xml:lang with this | |
| | | | | element | |
| Priority | E2 | M | 1 | Defines the priority of this notification | Integer |
| | | | | event. This information applied to | |
| | | | | generate presentation type of | |
| | | | | Notification Message. | |
| ExtensionURL | E2 | O | 0 . . . N | URL containing additional information | AnyURI |
| | | | | related to notification message | |
| MediaInformation | E2 | O | 0 . . . 1 | Media Information which is needed to | |
| | | | | construct multimedia notification | |
| | | | | messages. | |
| | | | | Contains the following elements: | |
| | | | | Picture | |
| | | | | Video | |
| | | | | Audio | |
| Picture | E3 | O | 0 . . . N | Defines how to obtain a picture and | |
| | | | | MIME type. | |
| | | | | Contains the following elements: | |
| | | | | MIMEtype | |
| | | | | PictureURI | |
| MIMEtype | A | O | 0 . . . 1 | MIME type of Picture | String |
| PictureURI | A | O | 0 . . . 1 | The URI referencing the picture | AnyURI |
| Video | E3 | O | 0 . . . N | Defines how to obtain a video and | |
| | | | | MIME type. | |
| | | | | Contains the following elements: | |
| | | | | MIMEtype | |
| | | | | VideoURI | |
| MIMEtype | A | O | 0 . . . 1 | MIME type of Video | String |
| VideoURI | A | O | 0 . . . 1 | The URI referencing the video | AnyURI |
| Audio | E3 | O | 0 . . . N | Defines how to obtain an audio and | |
| | | | | MIME type. | |
| | | | | Contains the following elements: | |
| | | | | MIMEtype | |
| | | | | AudioURI | |
| MIMEtype | A | O | 0 . . . 1 | MIME type of Audio | String |
| AudioURI | A | O | 0 . . . 1 | The URI referencing the audio | AnyURI |

The key information elements in Table 4 will be described hereinbelow.

CCNTEId is a unique identifier indicating the CCNTEReq message delivered by the CC, and is expressed in a 32-bit unsigned integer. CCAddress indicates a URL address of the CC that desires to receive a response to the CCNTEReq message. An information element ‘NotificationEvent’ indicating notification event information includes NotificationType and Validity as attributes, and Name, Description, Priority, ExtensionURL, and MediaInformation as sub-elements. MediaInformation can include Picture, Video, and Audio together with Multipurpose Internet Mail Extension (MIME) Type and URI.

TABLE 5

| Name | Type | Category | Cardinality | Description | Data Type |
|---|---|---|---|---|---|
| CCNTERes | E | M | 0 . . . N | Specifies the Response message for | |
| | | | | CCNTEReq. | |
| | | | | Contains the following elements: | |
| | | | | CCNTEId | |
| CCNTEId | E1 | M | 0 . . . N | Identifier of CCNTEReq | unsignedInteger |
| | | | | Contains the following attributes: | (32 bits) |
| | | | | Response | |
| Response | A | M | 1 | Specifies the result how SGCCSReq is | Interger |
| | | | | handled in SGAS. | (8 bits) |
| | | | | If Response = 0, Notification Event is | |
| | | | | generated and delivered to NTG. | |
| | | | | If Response = 1, Notification Event | |
| | | | | Generation is failed and Retransmission | |
| | | | | is requested. | |

As shown in Table 5, CCNTEId included in the CCNTERes message is equal to that included in the corresponding CCNTEReq message. An attribute ‘Response’ indicating the generation result on the notification event has one of a Status Code=‘0’ indicating Success and a Status Code=‘1’ indicating Fail.

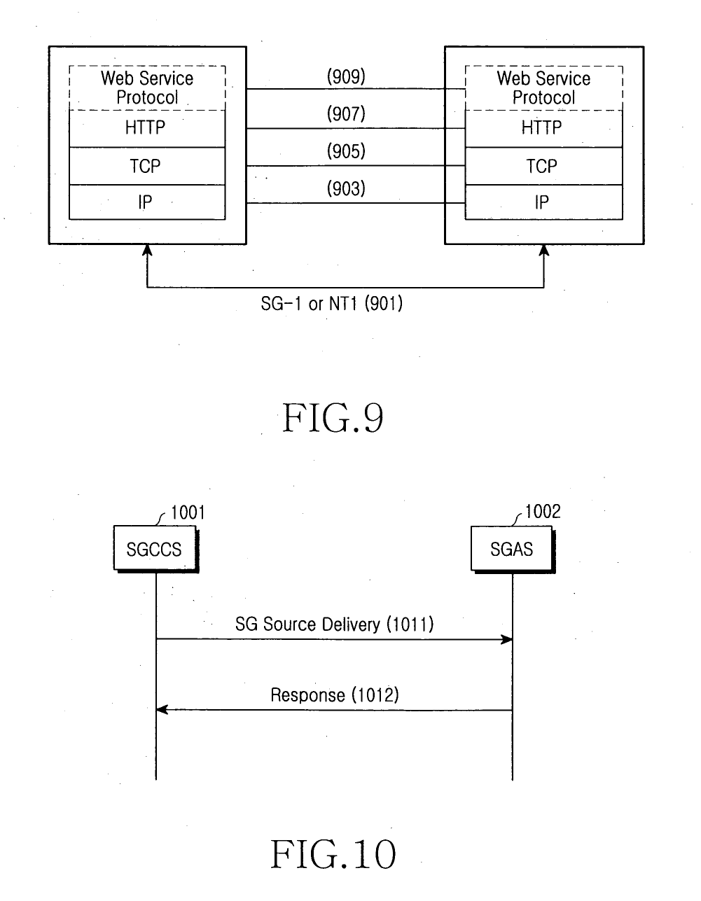

FIG. 9 is a diagram illustrating a protocol stack used for providing service guide source data necessary for generation of a service guide or delivering a request message for notification event information. As illustrated, an SG-1 interface or an NT-1 interface 901 is used as a backend interface between an SGCCS and an SGAS for delivering service guide source data or requesting notification event information.

Referring to FIG. 9, for message transmission over the SG-1/NT-1 interface 901, an HTTP 907 based on an IP 903 and a TCP 905 is used, as shown in FIG. 5 or 7. As another example, a Web Service Protocol 909 for XML data transmission, such as Simple Object Access Protocol (SOAP), Extensible Markup Language-Remote Procedure Call (XML-RPC) and Blocks Extensible Exchange Protocol (BEEP), can be used in an upper layer of the HTTP 907. When the Web Service Protocol 909 is used, the message is transmitted along with BODY of the Web Service Protocol.

FIG. 10 is a signaling diagram illustrating an operation of delivering service guide (SG) source data over an SG-1 interface according to the present invention.

Referring to FIG. 10, in step 1011, an SGCCS 1001 delivers SG source data necessary for SG generation to an SGAS 1002 using an SG-1 interface. An XML schema of a request message for delivering the SG source data is shown in Table 6 below. In step 1012, in response to the request message, the SGAS 1002 sends the processing result on the SG source data to the SGCCS 1001 through a response message with the XML schema shown in Table 7 below.

TABLE 6

| Name | Type | Category | Cardinality | Description | Data Type |
|---|---|---|---|---|---|
| SGSDelivery | | | | Specifies the delivery message of Service Guide | |
| | | | | Source that is used for generating Service Guide in | |
| | | | | SG-G. | |
| | | | | Contains the following attributes: | |
| | | | | Id | |
| | | | | EntityAddress | |
| | | | | Contains the following elements: | |
| | | | | SGData | |
| SGSDid | A | M | 1 | Identifier of SGSDelivery, unique in Network | unsignedInt |
| | | | | Entity which generated this message | (32 bits) |
| EntityAddress | A | M | 1 | Network Entity Address that generates this message | anyURI |
| | | | | and receives the response. | |
| SGData | E1 | O | 0 . . . 1 | Contains information from the Content Creation to | |
| | | | | be included into the Service Guide. It is | |
| | | | | RECOMMENDED that the information be | |
| | | | | delivered in the form of BCAST Service Guide | |
| | | | | fragments. Other formats MAY be used. | |
| | | | | If BCAST Service Guide fragments are used, | |
| | | | | network-mandatory elements or attributes that are | |
| | | | | not relevant SHALL be delivered as empty field, | |
| | | | | network-optional elements or attributes that are not | |
| | | | | relevant SHALL NOT be instantiated. | |
| | | | | Contains attribute: | |
| | | | | namespace | |
| namespace | A | O | 0 . . . 1 | Set to the name of the BCAST Service Guide XML | anyURI |
| | | | | namespace to signal that the content of SGData is | |
| | | | | BCAST SG compliant. | |

TABLE 7

| Name | Type | Category | Cardinality | Description | Data Type |
|---|---|---|---|---|---|
| SGSDRes | E1 | M | 1 . . . N | Specifies the Response message for | unsignedInt(32 bit) |
| SGSDid | | | | SGSDelivery | |
| | | | | Contains the following elements: | |
| | | | | SGSDid | |
| | | | | Identifier of SGSDelivery Message | |
| | | | | Contains the following attributes: | |
| | | | | StatusCode | |
| StatusCode | A | M | 1 | Indicates the overall outcome how | unsignedByte |
| | | | | SGSDelivery is processed, according to the | |
| | | | | global status code. | |

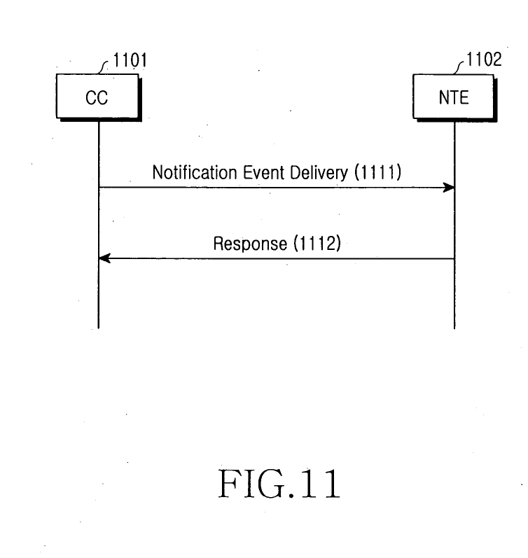

FIG. 11 is a signalling diagram illustrating an operation of delivering notification event information via an NT-1 interface according to the present invention. Herein, reference numeral 1101 indicates the CC 201 of FIG. 2, and reference numeral 1102 indicates the NTE 202-1 of FIG. 2.

Referring to FIG. 11, in step 1111, the CC 1101 delivers notification event information to the NTE 1102 using a request message formed as shown in Table 8 below. In step 1112, in response to the request message, the NTE 1102 sends the processing result on the notification event to the CC 1101 using a response message shown in Table 9 below.

TABLE 8

| Name | Type | Category | Cardinality | Description | Data Type |
|---|---|---|---|---|---|
| NTEReq | E | | | Specifies the delivery message of Notification | |
| | | | | Event for generating Notification Message. | |
| | | | | Contains the following attributes: | |
| | | | | NTEId | |
| | | | | EntityAddress | |
| | | | | DeliveryPriority | |
| | | | | Contains the following elements: | |
| | | | | NotificationEvent | |
| NTEId | A | M | 1 | Identifier of Notification Event | unsignedInt |
| | | | | | (32 bits) |
| EntityAddress | A | M | 1 | Network Entity Address to receive the response | anyURI |
| | | | | of this message. | |
| DeliveryPriority | A | O | 0 . . . 1 | Defines the priority of this notification | Boolean |
| | | | | event. This information is applied to generate | |
| | | | | Notification Message in NTG. NTG MAY be | |
| | | | | ignored this field | |
| NotificationEvent | E1 | M | 1 . . . N | Specifies the Notification Event, containing | |
| | | | | information to be included into the notification | |
| | | | | message. It is RECOMMENDED that the | |
| | | | | information be delivered in the form of BCAST | |
| | | | | notification message format. Other formats | |
| | | | | MAY be used. | |
| | | | | If BCAST notification message format is used, | |
| | | | | network-mandatory elements or attributes that | |
| | | | | are not relevant SHALL be delivered as empty | |
| | | | | field, network-optional elements or attributes | |
| | | | | that are not relevant SHALL NOT be | |
| | | | | instantiated. | |
| | | | | Contains attribute: | |
| | | | | Namespace | |
| Namespace | A | O | 0 . . . 1 | Set to the name of the BCAST | anyURI |
| | | | | notification XML namespace to signal that the | |
| | | | | content of NotificationEvent is compliant with | |
| | | | | BCAST notification message format. | |

TABLE 9

| Name | Type | Category | Cardinality | Description | Data Type |
|---|---|---|---|---|---|
| NTERes | | | | Specifies the Response message for NTEReq | |
| | | | | Contains the following elements: | |
| | | | | NTEid | |
| NTEid | E1 | M | 1 . . . N | Identifier of NTEReq Message | unsignedInt(32 bit) |
| StatusCode | A | M | 1 | Contains the following attributes: | unsignedByte |
| | | | | StatusCode | |
| | | | | Indicates the overall outcome how NTEReq is | |
| | | | | processed, according to the global status code. | |

Table 10 below shows preferred status codes included in the response messages shown in Tables 7 and 9. The following status codes can also be used in the response messages of Tables 3 and 5. That is, the response messages include 5 the status codes indicating the processing result on the SG source data or the notification event. When the SG source data or the notification event is normally processed, the status code becomes ‘000’, and the terminal recognizes the successful processing result according to the status code.

TABLE 10

| Code | Status |
|---|---|
| 000 | Success |
| | The request was processed successfully. |
| 001 | Device Authentication Failed |
| | This code indicates that the BSM was unable to authenticate the device, which may be due to |
| | the fact that the user or the device is not registered with the BSM. |
| | In this case, the user may contact the BSM, and establish a contract, or establish the |
| | credentials that are used for authentication. |
| 002 | User Authentication Failed |
| | This code indicates that the BSM was unable to authenticate the user, which may be due to |
| | the fact that the user or the device is not registered with the BSM. |
| | In this case, the user may contact the BSM, and establish a contract, or establish the |
| | credentials that are used for authentication. |
| 003 | Purchase Item Unknown |
| | This code indicates that the requested service item is unknown. This can happen e.g. if the |
| | device has a cached service guide with old information. |
| | In this case, the user may re-acquire the service guide. |
| 004 | Device Authorization Failed |
| | This code indicates that the device is not authorized to get Long-Term Key Messages from |
| | the RI, e.g. because the device certificate was revoked. |
| | In this case, the user may contact the BSM operator. |
| 005 | User Authorization Failed |
| | This code indicates that the user is not authorized to get Long-Term Key Messages from the |
| | RI, e.g. because the device certificate was revoked. |
| | In this case, the user may contact the BSM operator. |
| 006 | Device Not Registered |
| | This code indicates that the device is not registered with the RI that is used for the |
| | transaction. |
| | When this code is sent, the response message includes a registration trigger that allows the |
| | device to register. |
| | In this case, the device may automatically perform the registration, and, if the registration is |
| | successful, re-initiate the original transaction. |
| 007 | Server Error |
| | This code indicates that there was a server error, such as a problem connecting to a remote |
| | back-end system. |
| | In such a case, the transaction may succeed if it is re-initiated later. |
| 008 | Mal-formed Message Error |
| | This code indicates that there has been a device malfunction, such as a mal-formed XML |
| | request. |
| | In such a case, the transaction may or may not (e.g. if there is an interoperability problem) |
| | succeed if it is re-initiated later. |
| 009 | Charging Error |
| | This code indicates that the charging step failed (e.g. agreed credit limit reached, account |
| | blocked) and therefore the requested Long-Term Key (LTK) Message cannot be provided. |
| | The user may in such a case contact the BSM operator. |
| 010 | No Subscription |
| | This code indicates that there has never been a subscription for this service item, or that the |
| | subscription for this item has terminated. |
| | The user may in such a case issue a service request for a new subscription. |
| 011 | Operation not Permitted |
| | This code indicates that the operation that the device attempted to perform is not permitted |
| | under the contract between BSM and user. |
| | The user may in this case contact BSM operator and change the contract. |
| 012 | Unsupported version |
| | This code indicates that the version number specified in the request message is not supported |
| | by the network. |
| | In this case, the user may contact the BSM operator. |
| 013 | Illegal Device |
| | This code indicates that the device requesting services is not acceptable to the BSM. E.g. |
| | Blacklisted. |
| | In this case, the user may contact the BSM operator. |
| 014 | Service Area not Allowed |
| | This code indicates that the device is not allowed services in the requested area due to |
| | subscription limits |
| | In this case, the user may contact the BSM operator or subscribe to the applicable service. |
| 015 | Requested Service Unavailable |
| | This code indicates that the requested service is unavailable due to transmission problems. |
| | In this case, the request may re-initiated at a later time. |
| 016 | Request already Processed |
| | This code indicates that an identical request has been previously processed. |
| | In this case, the user or the entity may check to see if the request had already been processed |
| | (i.e. received an LTK); if not, then retry the request. |
| 017 | Information Element Non-existent |
| | This code indicates that the message includes information elements not recognized because |
| | the information element identifier is not defined or it is defined but not implemented by the |
| | entity receiving the message. |
| | In this case related entities should contact each other. |
| 018 | Unspecified |
| | This code indicates that an error has occurred which cannot be identified. |
| | In this case related entities should contact each other. |
| 019 | Process Delayed |
| | Due to heavy load, request is in the cue, waiting to be processed. |
| | In this case the user or entity should wait for the transaction to complete. |
| 020 | Generation Failure |
| | This code indicates that the request information (message) could not be generated. |
| | In this case the user or entity should retry later. |
| 021 | Information Invalid |
| | This code indicates that the information given is invalid and cannot be used by the system. |
| | In this case the request should be rechecked and resent. |
| 022 | Invalid Request |
| | This code indicates that the requesting key materials and messages (e.g., LTK) are not valid |
| | and can not be fulfilled. |
| | In this case the request should be rechecked and resent. |
| 023 | Wrong Destination |
| | This code indicates that the destination of the message is not the intended one. |
| | In this case the request should be rechecked and resent. |
| 024 | Delivery of Wrong Key Information |
| | This code indicates that the delivered key information and messages (e.g., LTK) are invalid. |
| | In this case the request should be rechecked and resent. |
| 025˜127 | Reserved for future use |
| 128˜255 | Reserved for proprietary use |

Table 10 is stored in a network entity and a terminal, which send a response message, and additional values can be defined according to purpose of service providers. In addition, the status code values shown in Table 10 can be used in the global use not only for the response messages associated with the present invention, but also for all response messages for delivering the processing result in the system or terminal providing supporting mobile broadcast service. In this light, the status code is also known as a global status code.

As can be understood from the foregoing description, the present invention defines a content information provisioning message for a service guide and a notification event message from the CC for notification event generation so that the CC may deliver content information and notification event for service guide generation in a mobile broadcast system, and provides an operation of delivering the messages and responding thereto. The BSA sends the result on the operation through each response message, thereby improving reliability for an operation of handling the messages from the CC. After completing the operation, the BSA can send the response messages in a bundle, thereby contributing to an increase in the network efficiency.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting information necessary for generation of a notification event for a mobile broadcast (BCAST) service in a wireless communication/broadcast system supporting the BCAST service, the method comprising the steps of:
generating, by a Content Creation (CC) for providing the BCAST service, a request message including notification event information and attributes for requesting generation of a notification event indicating a change in the BCAST service, and transmitting the request message to a Notification Event Function (NTE) in a BCAST Service Application (BSA) block;
generating, by the NTE, the notification event using the notification event information and attributes included in the request message, and transmitting a response message indicating the generation result on the notification event to the CC; and
transmitting, by the NTE, the notification event to a Notification Generation function (NTG) in a BCAST Subscription Management (BSM) block in order to generate a notification message indicating the notification event, to be transmitted to at least one terminal receivable the BCAST service.

2. The method of claim 1, wherein the response message is included in a Hyper Text Transfer Protocol (HTTP) RESPONSE message comprising an identifier indicating the request message, if the notification event is generated immediately upon receipt of the request message.

3. The method of claim 1, wherein the response message is included in a Hyper Text Transfer Protocol (HTTP) POST message and the HTTP POST message includes a unique identifier for identifying the request message if the notification event is not generated immediately upon receipt of the request message.

4. The method of claim 1, wherein the request message includes:
a identifier NTEId indicating the request message;
an entity address indicating an address of the CC that desires to receive a response to the request message;
a priority of the notification event information to be applied for generation of the notification message in the NTG; and
at least one of attributes of NotificationType and Validity as information elements necessary for generation of the notification event, and attributes of Name, Description, ExtensionURL and MediaInformation as sub-elements.

5. The method of claim 4, wherein the MediaInformation includes at least one of Picture, Video and Audio information together with Multipurpose Internet Mail Extension (MIME) type and corresponding URI.

6. The method of claim 1, wherein the response message includes:
a identifier NTEId indicating the request message that the CC transmits; and
a status code value indicating the processing result on the notification event.

7. An apparatus for transmitting information necessary for generation of a notification event for a mobile broadcast (BCAST) service in a wireless communication/broadcast system supporting the BCAST service, the apparatus comprising:
a Content Creation (CC) providing the BCAST service, for generating a request message including notification event information and attributes for requesting generation of a notification event indicating a change in the BCAST service;
a Notification Event Function (NTE) in a BCAST Service Application (BSA) block, for generating a notification event using the notification event information and attributes included in the request message, and transmitting a response message indicating the generation result on the notification event to the CC; and
a Notification Generation function (NTG) in a BCAST Subscription Management (BSM) block, for receiving the notification event message from the NTE, and generating a notification message indicating the notification event, to be transmitted to at least one terminal receivable the BCAST service.

8. The apparatus of claim 7, wherein the response message is included in a Hyper Text Transfer Protocol (HTTP) RESPONSE message comprising an identifier indicating the request message, if the notification event is generated immediately upon receipt of the request message.

9. The apparatus of claim 7, wherein the response message is included in a Hyper Text Transfer Protocol (HTTP) POST message and the HTTP POST message includes a unique identifier for identifying the request message if the notification event is not generated immediately upon receipt of the request message.

10. The apparatus of claim 7, wherein the request message includes:
a unique identifier NTEId indicating the request message;
an entity address indicating an address of the CC that desires to receive a response to the request message;
a priority of the notification event information to be applied for generation of the notification message in the NTG; and
at least one of attributes of NotificationType and Validity as information elements necessary for generation of the notification event, and attributes of Name, Description, ExtensionURL and MediaInformation as sub-elements.

11. The apparatus of claim 10, wherein the MediaInformation includes at least one of Picture, Video, and Audio information, together with Multipurpose Internet Mail Extension (MIME) type and corresponding URI.

12. The apparatus of claim 7, wherein the response message includes:
a unique identifier NTEId indicating the request message that the CC transmits; and
a status code value indicating the processing result on the notification event.

13. A method for transmitting information necessary for generation of a service guide (SG) for a mobile broadcast (BCAST) service in a wireless communication/broadcast system supporting the BCAST service, the method comprising the steps of:
generating, by a Service Guide Content Creation Source (SGCCS) in a Content Creation (CC) for providing the BCAST service, a request message including a source data necessary for generation of the SG, and transmitting the source data to a Service Guide Application Source (SGAS) in a BCAST Service Application (BSA) block;
forwarding, by the SGAS, the source data to Service Guide Generation (SG-G) block in a BCAST Service Distribution/Adaptation (BSD/A) block to generate the SG, and transmitting a response message indicating the processing result on the source data to the SGCCS; and
generating, by the SG-G, the SG using the source data to be transmitted to at least one terminal receivable the BCAST service.

14. The method of claim 13, wherein the response message is included in a Hyper Text Transfer Protocol (HTTP) RESPONSE message comprising an identifier indicating the request message, if the source data is processed immediately upon receipt of the request message.

15. The method of claim 13, wherein the response message is included in a Hyper Text Transfer Protocol (HTTP) POST message and the HTTP POST message includes a unique identifier for identifying the request message if the source data is not processed immediately upon receipt of the request message.

16. The method of claim 13, wherein the request message includes:
a identifier SGCCSId indicating the request message; and
an entity address indicating an address of the CC that desires to receive a response to the request message; and
at least one of Content Type, Content Length, and Content Encoding as Content Information from the CC to be included into the SG.

17. The method of claim 13, wherein the response message includes:
a identifier SGCCSId indicating the request message that the CC transmits; and
a status code value indicating the processing result on the source data.

18. An apparatus for transmitting information necessary for generation of a service guide (SG) a mobile broadcast (BCAST) service in a wireless communication/broadcast system supporting the BCAST service, the apparatus comprising:
a Service Guide Content Creation Source (SGCCS) in a Content Creation (CC) providing the BCAST service, for generating a request message including a source data necessary for generation of the SG;
a Service Guide Application Source (SGAS) in a BCAST Service Application (BSA) block, for receiving the request message including a source data, and transmitting a response message indicating the processing result on the source data to the SGCCS; and
a Service Guide Generation (SG-G) block in a BCAST Service Distribution/Adaptation (BSD/A) block, for receiving the source data from the SGAS, and generating the SG using the source data, to be transmitted to at least one terminal receivable the BCAST service.

19. The apparatus of claim 18, wherein the response message is included in a Hyper Text Transfer Protocol (HTTP) RESPONSE message comprising an identifier indicating the request message, if the source data is processed immediately upon receipt of the request message.

20. The apparatus of claim 18, wherein the response message is included in a Hyper Text Transfer Protocol (HTTP) POST message and the HTTP POST message includes a unique identifier for identifying the request message if the source data is not processed immediately upon receipt of the request message.

21. The apparatus of claim 18, wherein the request message includes:
a identifier SGCCSId indicating the request message;
an entity address indicating an address of the CC that desires to receive a response to the request message;
a priority of the notification event information to be applied for generation of the notification message in the NTG; and
at least one of Content Type, Content Length, and Content Encoding as Content Information from the CC to be included into the SG.

22. The apparatus of claim 18, wherein the response message includes:
a identifier SGCCSId indicating the request message that the CC transmits; and
a status code value indicating the processing result on the source data.
